(19) United States
(12) Patent Application Publication
(10) Pub. No.: US 2016/0234139 A1
(43) Pub. Date: Aug. 11, 2016

(54) Classification Based Email Construction, Work Flow, and Dashboard Rendering

(71) Applicant: Angela Christine Botner, Solon Springs, WI (US)

(72) Inventor: Angela Christine Botner, Solon Springs, WI (US)

(21) Appl. No.: 14/617,839

(22) Filed: Feb. 9, 2015

(51) Int. Cl. H04L 12/58; G06Q 10/10

(52) U.S. Cl. CPC H04L 51/046; H04L 51/063; G06Q 10/107

(57) ABSTRACT

This solution suggests a complete transformation of the conventional email utility from the unstructured text body format of the compose message function to an interactive dashboard that allows for focused, categorical workflow of outbound-initiated transactions based on universally recognized business activities. These classifications allow for organized presentation of inbound activities assigned. It will provide benefits in that the user will know where to find key activities and information based on the classifications presented, and the most urgent items will show at the top of any inbound list. It will allow for automatic priority assignment and enable customized classification behaviors, such as selective archival of formal business and project related decisions. The potential values are reduction in unnecessary email volume generated, less data to manage and store, reduced costs for data retrieval and discovery activities, an ability to apply more granular configurable data retention policies, improved communication, and increased productivity.

### BACKGROUND

Today's business associates interact with a visual representation of email inventory list that is typical to the example shown in FIG. 1. To initiate a new email message, authors conventionally execute a function that launches a form containing a box in which to select the recipient(s), a box to delineate a subject, and a large unstructured text body that is designed to convey the request, purpose, question, task, and relative criticality. Upon sending the message, the email message gets added to the running inventory list. As inventory accumulates, it results in a significant time commitment to manage tasks and locate information, commonly known as email overload. Its current unstructured format does not allow for consistent and accurate classification. Furthermore, many enterprises have adopted policies that automatically purge messages after 90 days, which could result in important documents and decisions being lost.

### BRIEF SUMMARY

The solution proposed is a radical redesign of traditional email user interface and its related functions to eliminate the generation of massive quantities of unstructured data. It will enable dynamically assigned classification of work-flow-based activities from pre-configured templates based on standard business activities. This will not only directly support project management activities and governance, but all other business operations on a universal scale.

This solution drives classification of historically unstructured data into meaningful categories. It is singular in nature, allowing for deliberate configuration options based on workflow and transaction type. For example, the formal approvals and signatures workflows could be automatically archived at the enterprise level for seven years as these are directly related to critical business decisions and operations. By virtue of an initiator requesting a signature or formal decision, that action infers a level of significance which would trigger a higher level of retention and archival than that of a garden variety task assignment. It is a scalable, flexible, adoptable solution, regardless of industry.

From a role based perspective, the benefits are notable. Executives that receive a very large volume of email would benefit from receiving a virtual dashboard of categorized information. They could easily locate approvals requested of them, easily locate areas of concern or risk, and easily find status for critical initiatives. Project managers will gravitate to heavy use of the viewing outbound work that has been initiated by them. For tasks recipients, the most critical items scheduled will automatically present at the top of the list.

Benefits can also be gained in that the templates provided based on outbound activity selected help to provide guidance to the composer to ensure that the right amount of information is included. Because the activities are structured, receivers can begin to know where to look for specific content rather than sifting through an unstructured email text body to find a particular piece of information.

### DETAILED DESCRIPTION OF INVENTION

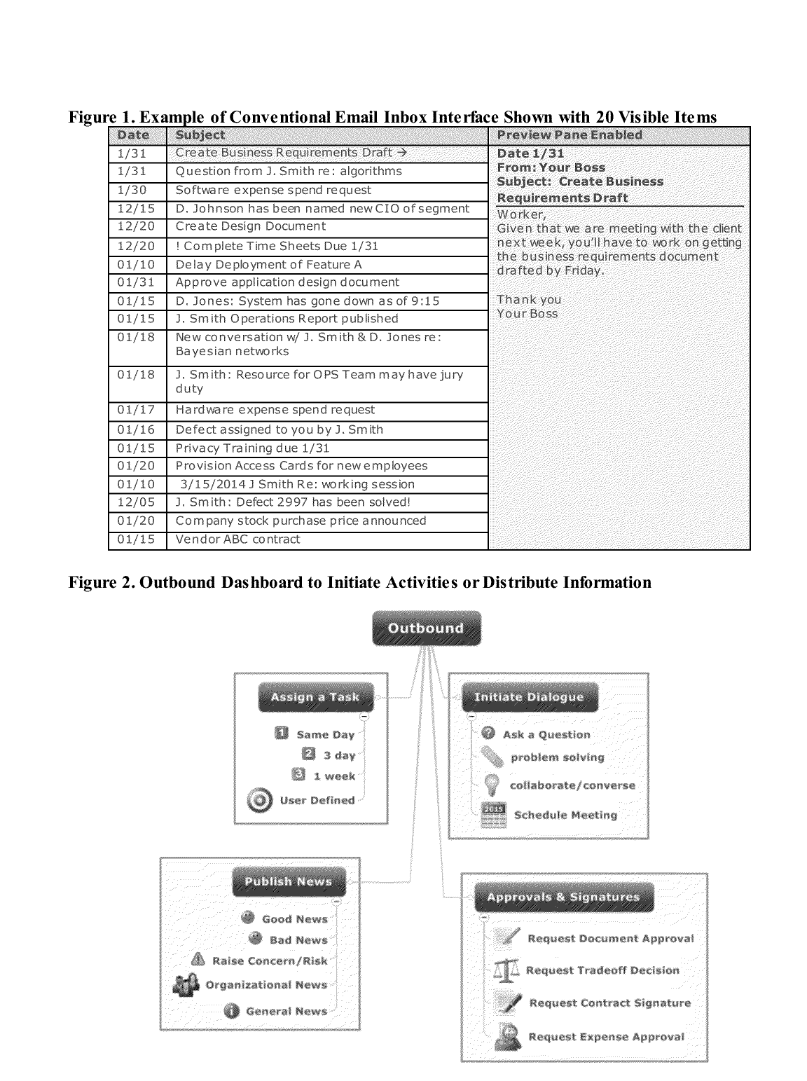

The proposed model can be broken down into two main categories of initiating and managing outbound activity (activities and/or information required of, or distributed to, others), and managing and resolving inbound activity (activities and/or information required of, or distributed to, the individual user). The outbound activity model (see FIG. 2) is controlled by an interactive dashboard with common activities that support the spectrum of project communications and business operations. It is divided into four main categories of task assignment, dialogue initiation, news publications, and formal signature and approval.

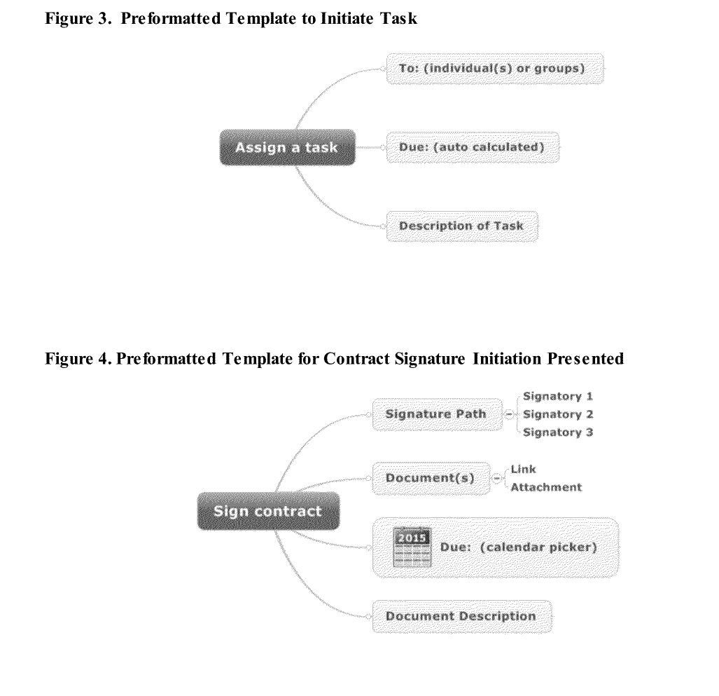

For each classification chosen, a preformatted template would be rendered that would enable rapid creation of transaction type. For example, if task was chosen, a form would render with due date calculated based on sub-type selected, or allow user-defined date range (see FIG. 3). The requestor would fill in the description of the task and the individual(s) or distribution list(s) assigned.

A selection of contract signature would allow initiator to identify all signatories, and a variable by which to attach the document or signify the document location (see FIG. 4). Auto forward would enable signature request to progress sequentially based on order of list.

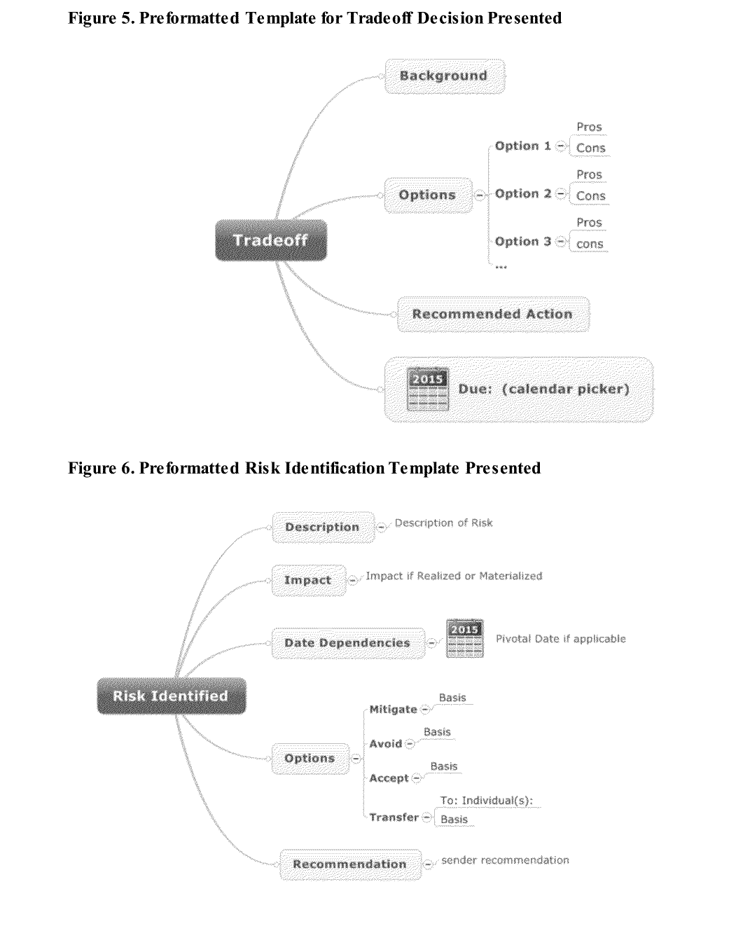

A tradeoff decision would initiate a semi structured form that allowed for requestor to articulate the options being considered, along with the benefits, limitations, and recommended action (see FIG. 5).

A selection of risk identification would initiate a preformatted template that allowed for requestor to supply information identified about a risk and available risk management options and recommendations (see FIG. 6). It is important to note that this particular activity is not meant to replace traditional risk management plans or activities. Rather, it is a mechanism to report out or highlight specific risk(s) that have surfaced as part of ongoing business activities. The structured notion of this (and other) activity would allow for potential extraction and systematic integration into centrally managed risk or project plans. Logically, the publication of the risk management plan in its entirety would be initiated using the General News category.

### Managing Outbound Inventory

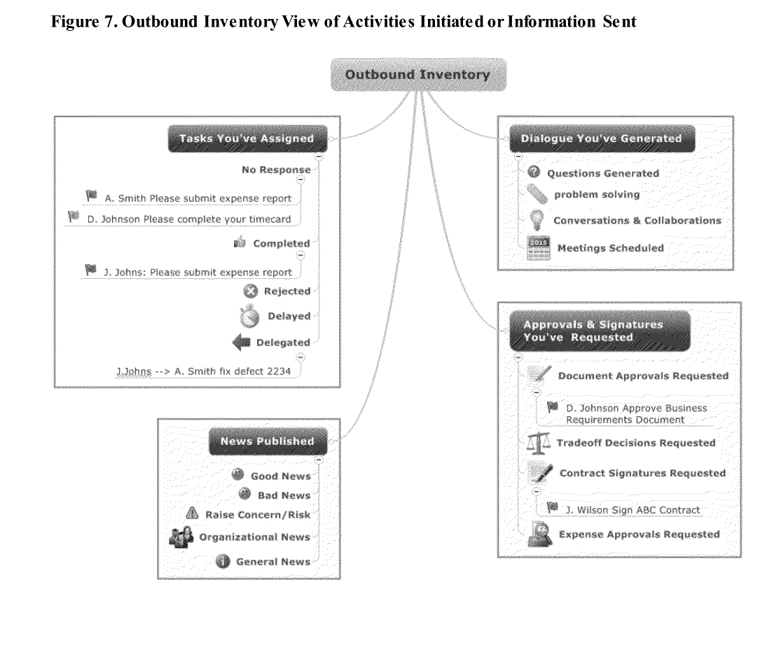

The user would also have an inventory view of all outbound activity that has been initiated. This view would allow the user to quickly assess status for key items. For example, as shown in FIG. 7, late tasks are shown as either past due date or approaching due date by a red or yellow flag. Tasks completed on time reflect a green indicator. The restructuring of activities into categorical views allows easy identification of trends. Reports could be developed based on the categorical responses to tasks assigned. For example, statistics could be generated based upon habitually late or rejected task response.

Enterprise configuration would set parameters for how long completed tasks or other inventory items could remain in view. A user option could also be enabled to hide completed tasks. Other interactive one-click actions that could be initiated could be an escalation feature. For example, if the user clicked on a red flag item, a follow-up transaction would be initiated to the assignee to escalate the outstanding item.

### Managing Inbound Activity

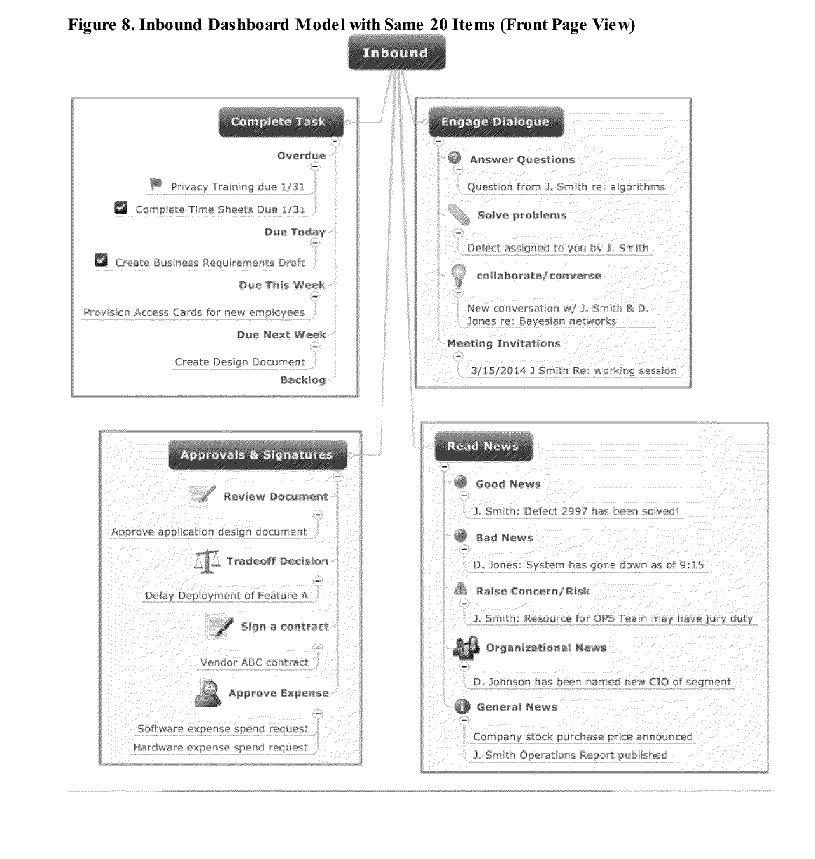

For inbound activity, FIG. 8 demonstrates an example of the same items illustrated in FIG. 1 populated into the redesigned inbound dashboard based on activities initiated and assigned to that individual from the outbound dashboard represented in FIG. 2 above.

The inbound view will allow recipient to see a meaningful representation and classification of work. Branches would be expandable or collapsible and can be configured to display an arbitrary amount, and would have totals next to each branch to signify volume of each type. Additionally, each of the four main categories could be expanded to a view that would focus on that particular type to show a larger inventory.

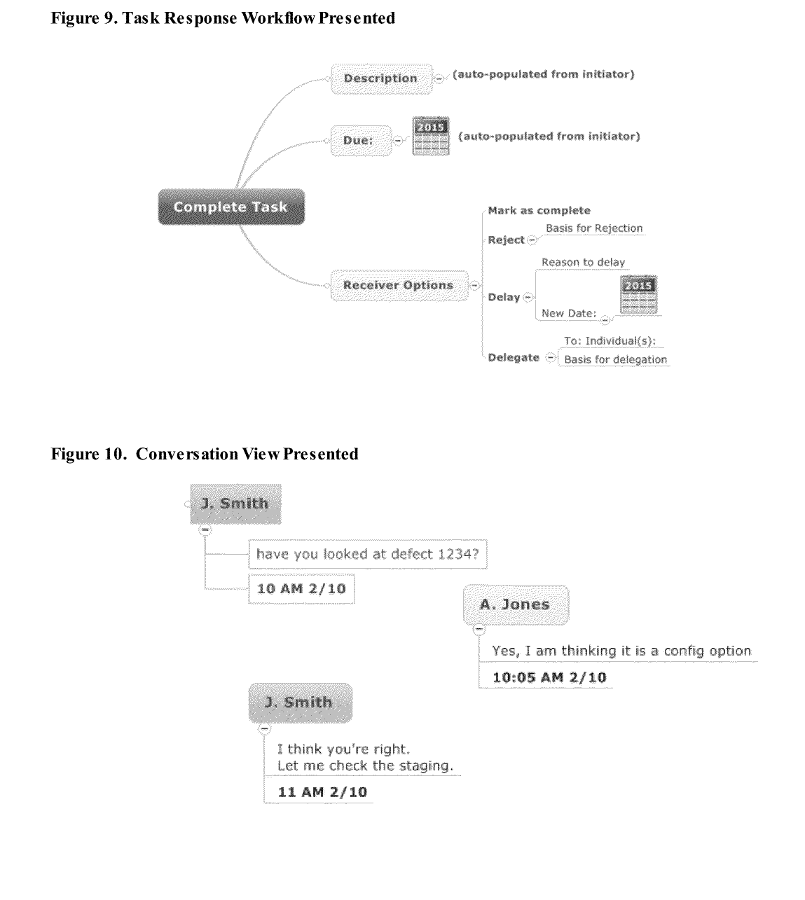

To resolve inbound items, user would select a line item, which would then expand into a semi-structured view for further action. For example, when selecting a task to complete, the view shown in FIG. 9 would be presented for resolution. A notable observation of the available actions for task management is that ‘delete’ is absent. Logically, there are a discrete number of options that are defined for tasks. A user must pick to complete, reject, delay or delegate the task assigned. All of these actions would then automatically generate feedback to initiator on the action taken. This enables the person to avoid generating the dreadful one word response emails that contain the single word ‘done’.

The News and Dialogue categories would allow for a delete function as News is designed to be a one-way message. Dialogue engages with one or more parties, but it is true conversation management as it relates to tactical activities. Approvals and Signatures are related to more strategic decisions and legal activities and therefore would automatically be governed by the retention guidelines configured by the enterprise.

Conversations and Questions would be represented as shown in FIG. 10. This shows a running dialogue associated with a single topic. This allows multiple conversation threads to be condensed into a single view.

1. An email utility that replaces traditionally known compose message email function and unstructured text to a purpose, milestone, and outcome driven activity, based on universal business functions performed.

2. An email interface that provides for a rendered interactive dashboard to display inventory organized by those functions, or classifications.

3. An email utility that provides for specific behaviors or functions to be invoked automatically based on the classification of the activity.

4. An outbound email interface that presents options to compose email messages based on four main email classifications and eighteen sub-classifications, comprised of following:
Assign Tasks
Same day
3 Day
1 week
User defined
Initiate Dialogue,
Ask a question
Problem solving
Collaborate and converse
Schedule a meeting
Publish News
Good News
Bad News
Raise Concern/Risk
Organizational news
General News
Marketing Campaign
Approvals & Signatures.
Request document approval
Request Tradeoff Decision
Request Contract Signature
Request Expense approval

5. Upon selection of a sub-classification as described in claim 4, the rendering of structured templates to populate information, which varies based on sub-classification chosen. Each sub-classification will have a send function.
Assign Tasks
Same day—assignee(s), description of task, due date (auto)
3 Day—assignee(s), description of task, due date (auto)
1 week—assignee(s), description of task, due date (auto)
User defined—assignee(s), description of task, due date (custom)
Initiate Dialogue,
Ask a question—assignee(s), background, question
Problem solving—assignee(s), background, problem description
Collaborate and converse assignee(s), Topic
Schedule a meeting—attendees(s), Date, Topic, Background, Agenda topics, meeting objectives/outcomes.
Publish News
Good News—addressee(s), Topic, Expiration Date
Bad News—addressee(s), Topic, Expiration Date
Raise Concern/Risk—addressee(s), Description, impact, Trigger Date, Options (mitigate, avoid, accept, transfer), recommendation
Organizational news—addressee(s), Topic/content, Expiration Date
General News—addressee(s), Topic/content, Expiration Date
Marketing Campaign—addressee(s), Content, Expiration Date
Approvals & Signatures.
Request document approval—assignee(s), background, document, due date
Request Tradeoff Decision—assignee(s), background, options, recommendation, due date
Request Contract Signature—signatory(ies), background, document, due date
Request Expense approval—approver(s), background, itemized list, costs, due date

6. The presentation and sorting of email messages received organized in to the said four main classifications and sub-classifications as described in claim 4 with exception of Tasks, which will render and populate based on sub-classifications as follows:
Overdue
Due Today
Due this week
Due next week
Backlog
Incoming inventory will then be populated with relative sorting based on due or expiration dates captured from data captured in claim 5 templates.

7. The enabled function to resolve each item populated in sub-classifications described in claim 6 as follows. Each has send function.
Task resolution options: single selectable values of mark complete, decline, delegate, delay, ask question, If delegate is chosen, new assignee is also required, if delay is chosen, date is also required.
News resolution options (all sub-classifications): delete or forward.
Dialogue
Question, Problem Solving and Collaborate sub-classifications consists of ongoing open conversational text exchange between one or more parties. Resolution options consist of delete or forward.
Meeting scheduling resolution options are to accept, decline, delegate, forward, or propose new time
Signatures and Approval options:
Review document options: approve, qualified approval, revise, disapprove. Basis text field also provided for supporting text.
Tradeoff Decision options: user can select one of the options outlined, decline all options outlined, suggest new option, and provide text basis in separate field.
Contract signature options: provide signature, request revision, decline, or delegate signature authority. Provide basis in separate text field.
Request expense approval options: approve, deny. Additional text field for qualifying information

8- The enablement of customized behaviors based upon each sub-classification as described in claim 6.
Tasks—
As recipient works and resolves (or fails to resolve) tasks and status changes, the view from sender's outbound view is automatically updated.
The enablement of completed tasks to be removed from view after a configurable period.
The escalation of overdue tasks by sender
News (all subclassifications)—automatic deletion after expiration date
Approvals and Signatures—automatic retention of all resolved sub-classifications based upon configurable period per sub-classification.
Dialogue—
Automatic retention based upon configurable period per sub-classification.
All sub-classifications retain singular continuous conversation window per initiated topic rather than initiating new item per each response.
